(19) United States
(12) Patent Application Publication
(10) Pub. No.: US 2021/0195884 A1
(43) Pub. Date: Jul. 1, 2021

(54) MITE ATTRACTING AGENT AND MITE CATCHER

(71) Applicant: NIKKAKU LABORATORY CO., LTD., Tatsuno-shi, Hyogo (JP)

(72) Inventor: Hideo WATANABE, Tatsuno-shi, Hyogo (JP)

(73) Assignee: NIKKAKU LABORATORY CO., LTD., Tatsuno-shi, Hyogo (JP)

(21) Appl. No.: 17/271,488

(22) PCT Filed: Dec. 3, 2019
(86) PCT No.: PCT/JP2019/047266

§ 371 Date: Feb. 25, 2021

(30) Foreign Application Priority Data
Dec. 6, 2018 (JP) 2018-229188

(51) Int. Cl. A01M 1/02; A01N 25/12; A01N 59/00; A01M 1/10; A01N 63/10

(52) U.S. Cl. CPC A01M 1/02; A01N 25/12; A01N 63/10; A01M 1/103; A01N 59/00

(57) ABSTRACT

There are provided a mite attracting agent including: a calcined shell; and a mite attracting composition containing a mite attracting substance, and a mite catcher including the above-described mite attracting agent. Preferably, the mite attracting agent further includes silica gel. The mite attracting agent can reduce a mite allergen.

### TECHNICAL FIELD

The present invention relates to a mite attracting agent and a mite catcher.

### BACKGROUND ART

A mite allergen is a main house dust allergen and causes allergic diseases such as allergic asthma, allergic rhinitis, conjunctivitis, and atopic dermatitis. Therefore, in order to prevent or alleviate the allergic diseases, the technique of reducing the mite allergen from the living environment is required.

In order to deal with the allergic diseases caused by mites serving as an allergen, it is conceivable to exterminate the mites serving as an allergen and eliminate the mites from the living environment. Japanese Patent Laying-Open No. 2001-89310 (PTL 1) discloses a catcher that attracts and kills mites serving as an allergen.

### CITATION LIST

### Patent Literature

PTL 1: Japanese Patent Laying-Open No. 2001-b 89310

### SUMMARY OF INVENTION

### Technical Problem

However, even if mites are exterminated using a catcher or the like, dead bodies and droppings of the mites serving as an allergen may cause the allergic diseases when they remain in the living environment. Therefore, the technique of further reducing the mite allergen is required.

It is an object of the present invention to provide a novel mite attracting agent and a novel mite catcher that can reduce a mite allergen.

### Solution to Problem

[1] A mite attracting agent including: a calcined shell; and a mite attracting composition containing a mite attracting substance.

[2] The mite attracting agent according to [1], wherein

the calcined shell is a powder.

[3] The mite attracting agent according to [1] or [2], wherein

the calcined shell includes a calcined shell derived from at least one selected from the group consisting of scallop, oyster and surf clam.

[4] The mite attracting agent according to any one of [1] to [3], wherein

a calcination temperature of the calcined shell is not less than 400° C. and not more than 1600° C.

[5] The mite attracting agent according to any one of [1] to [4], wherein

a ratio of the calcined shell to a total amount of the mite attracting agent is not less than 5% by mass.

[6] The mite attracting agent according to any one of [1] to [5], wherein

the mite attracting composition further includes a porous substance, and

at least a part of the mite attracting substance is impregnated into the porous substance.

[7] The mite attracting agent according to any one of [1] to [6], further including silica gel.

[8] The mite attracting agent according to [7], wherein

a ratio of the silica gel to a total amount of the mite attracting agent is not less than 5% by mass.

[9] A mite catcher including the mite attracting agent as recited in any one of [1] to [8].

### Advantageous Effects of Invention

According to the present invention, there can be provided a novel mite attracting agent and a novel mite catcher that can reduce a mite allergen.

### BRIEF DESCRIPTION OF DRAWINGS

FIG. 1 is a graph showing a Der f1 mite allergen reducing rate of a mite attracting agent in Experiment 1 (solution method).

FIG. 2 is a graph showing the Der f1 mite allergen reducing rate of the mite attracting agent in Experiment 2 (trace liquid method).

FIG. 3 is a graph showing a change in mite allergen reducing rate of a mite attracting agent in accordance with a content of a calcined shell in Experiment 3.

FIG. 4 is a graph showing a change in mite allergen reducing rate of a mite attracting agent in accordance with a content of a calcined shell in Experiment 4.

FIG. 5 is a graph showing a Der p1 mite allergen reducing rate of a mite attracting agent in Experiment 5.

FIG. 6 is a graph showing a mite allergen reducing rate of a test solution obtained by neutralizing a solution having a mite attracting agent suspended therein and a test solution obtained by neutralizing and filtering the solution having the mite attracting agent suspended therein in Experiment 6.

FIG. 7 is a graph showing a Der f1 mite allergen reducing rate of a mite attracting agent in Experiment 7 (powder method).

FIG. 8 is a graph showing a Der f1 mite allergen reducing rate of calcium hydroxide and a mite attracting agent in Experiment 8.

FIG. 9 is a graph showing a Der f1 mite allergen reducing rate of calcium oxide and a calcined shell in Experiment 9.

FIG. 10 is a graph showing a Der f1 mite allergen reducing rate of calcium oxide and a calcined shell in Experiment 10.

FIG. 11 is a graph showing a Der f1 mite allergen reducing rate of a shell calcined at various temperatures in Experiment 11.

### DESCRIPTION OF EMBODIMENTS

<Mite Attracting Agent>

A mite attracting agent includes:

[A] a calcined shell; and

[B] a mite attracting composition containing a mite attracting substance.

[A] Calcined Shell

A shell is a hard tissue secreted onto an outer surface of a mantle by shellfish. Although not particularly limited, the shell is derived from, for example, scallop, oyster, surf clam, abalone, mussel, turban shell, hard clam, short-neck clam, freshwater clam or the like. The shell may include a brachiopod-derived or arthropod-derived shell, coral, a nacreous layer, an eggshell or the like.

Not less than 90% by mass of the shell is, for example, composed of calcium carbonate, although it varies depending on a shell type. In addition to calcium carbonate, the shell may include a trace component such as MgO, SiO₂ and iron oxide. Since calcium carbonate in the shell is converted into calcium oxide by calcination, the calcined shell includes calcium oxide. Although the conversion rate varies depending on a calcination temperature and the calcination time, calcium oxide included in the high-temperature-calcined shell is, for example, about not less than 50% by mass and not more than 100% by mass. In addition, the calcined shell is porous. The calcined shell can reduce a mite allergen.

When calcium oxide generated by calcination is dissolved in water, calcium oxide is converted into calcium hydroxide. Due to the strong alkalinity caused by a hydroxyl ion of calcium hydroxide, a strong allergen reducing effect is provided. In contrast, when the low-temperature-calcined shell that is not so much converted into calcium oxide and is mainly composed of calcium carbonate is dissolved in water, the low-temperature-calcined shell shows neutrality. However, the low-temperature-calcined shell has the mite allergen reducing effect. Therefore, it is expected that the allergen reducing effect provided by the calcined shell is established by a plurality of mechanisms. In addition, the calcined shell also provides a strong sterilization effect.

Since the calcined shell is made of a natural product, the calcined shell is extremely high in safety and small in environmental load. In addition, in the calcined shell, the degree of purity of calcium oxide is higher and an amount of iron, sulfur, manganese, magnesium, aluminum or the like is smaller than in quicklime obtained by calcining natural limestone. In addition, when the calcined shell is pulverized, a small particle size can be achieved.

A large amount of shells occur as a result of consumption of shellfish. Among them, shells of scallop, oyster and surf clam that grow fast and are consumed in large amount can be suitably used because the shells are available at low cost and can contribute to resource saving and environmental preservation as effective use of wastes. In addition, shells of scallop or oyster are preferable because the shells have a regular calcite-type crystal structure and are excellent in porosity after calcination. A commercially available shell can be used as the calcined shell.

The calcined shell is preferably a powder or fibrous, and more preferably a powder. A shell powder obtained by subjecting a shell to heat treatment as it is and then mechanically pulverizing the shell, or a shell powder obtained by mechanically pulverizing a shell and then subjecting the shell to heat treatment can be used as the powder of the calcined shell. Pulverization may be performed only once, or may be performed twice or more. In addition, the shell may be preliminarily pulverized to a powder of approximately several millimeters, and then calcined, and then finely pulverized. The preliminary pulverization increases the heating efficiency during calcination and provides a porous structure that is easily finely pulverized by heating. The details will be described below.

First, an unneeded shell is washed with water and dried, and then, is preliminarily pulverized. Although a pulverization method is not particularly limited, pulverization can be performed by human power or by using a crusher or a hammer mill. Thereafter, the preliminarily pulverized shell is calcined.

Although a calcination method and a calcination condition are not particularly limited, the calcination temperature is, for example, not less than 400° C. and not more than 1600° C. In order to obtain the stronger mite allergen reducing effect, the calcination temperature is preferably as high as approximately not less than 800° C. and not more than 1200° C. The calcination temperature may be not less than 700° C., or may be not less than 900° C., or may be not less than 1000° C. This is because calcium oxide is sufficiently generated as a main component. In order to obtain the relatively gentle mite allergen reducing effect, the calcination temperature is preferably as low as approximately not less than 400° C. and not more than 800° C. In this case, calcium carbonate is a main component. “As a main component” herein refers to not less than 50% by mass of the calcined shell.

Although the calcination time depends on the calcination temperature, the calcination time is preferably not less than 30 minutes and not more than 15 hours, more preferably not less than 1.5 hours and not more than 6 hours, and further preferably not less than 2 hours and not more than 4 hours. A continuous-type kiln in which preliminary heating is performed at a temperature lower than a prescribed temperature by approximately 300° C. to 500° C. before heating at the prescribed temperature may be used. When the calcination temperature is too high or the calcination time is too long, the calcium oxide particles may vitrify or the physical strength may decrease. In contrast, when the calcination temperature is too low or the calcination time is too short, there is a possibility that sufficient conversion from calcium carbonate that is a component of the shell to calcium oxide is not performed, or a uniform particle size is less likely to be obtained by subsequent fine pulverization.

A calcination apparatus is not particularly limited, either, and a general calcination apparatus can be used. A Beckenbach kiln, a Maerz kiln, a rotary kiln, a Kunii-type kiln, a KHD kiln, a top-type kiln, a Calcimatic kiln, a fluidized-bed calcination kiln, a mixing calcination shaft kiln, an electrically heated kiln or the like can be used as the calcination apparatus. The atmosphere during calcination may be in the air, in an inert gas such as nitrogen, in a vacuum, or the like.

By further finely pulverizing the calcined shell powder, the powder having a prescribed particle size can be obtained. Although a fine pulverization method is not particularly limited, a dry-type or wet-type known pulverizer such as, for example, a ball mill, a bead mill or a jet mill can be used.

A number average particle size of the finely pulverized powder is preferably not less than 100 nm and not more than 5 mm, more preferably not less than 500 nm and not more than 500 μm, and further preferably not less than 1 μm and not more than 50 μm. When the number average particle size of the powder is within this range, the allergen reducing effect can last a long time and a blending amount of the powder can be increased. The number average particle size of the shell powder can be determined in accordance with an ordinary method, using a laser diffraction and scattered light-type Microtrac particle size distribution measuring apparatus (manufactured by MicrotracBEL Corp.).

A specific surface area of the calcined shell powder is preferably not less than 0.50 m²/g and not more than 200 m²/g, more preferably not less than 0.1 m²/g and not more than 30 m²/g, and further preferably not less than 0.1 m²/g and not more than 10 m²/g. The specific surface area can be determined in accordance with a gas adsorption method. When the specific surface area of the shell powder is too small, contact with the allergen may be poor and thus the allergen reducing effect cannot in some cases be provided sufficiently. The specific surface area can be measured in accordance with JIS Z8830:2013 (BET specific surface area measurement method of powder (solid) by gas adsorption).

The calcined shell powder includes pores having an average pore size of preferably not less than 0.1 μm and not more than 10 μm, and more preferably not less than 0.5 μm and not more than 5 μm. The pore size can be determined in accordance with mercury porosimetry. When the pore size is within this range, contact with the allergen is good and the allergen reducing effect is further enhanced.

A ratio of the calcined shell to a total amount of the mite attracting agent is preferably not less than 5% by mass and not more than 50% by mass, more preferably not less than 10% by mass and not more than 30% by mass, and further preferably not less than 15% by mass and not more than 30% by mass. When the ratio of the calcined shell powder is too low, the sufficient mite allergen reducing effect cannot be obtained for a high allergen concentration. Silica gel described below tends to repel mites when a content of the silica gel in the mite attracting agent is too high. In contrast, the calcined shell does not repel mites even when a content of the calcined shell in the mite attracting agent is high.

[B] Mite Attracting Composition

The mite attracting composition contains a mite attracting substance.

[Mite Attracting Substance]

The mite attracting substance is not particularly limited, as long as it is a substance that attracts mites. However, a dietary attracting substance, an aromatic attracting substance or the like can be used as the mite attracting substance. Dried yeast such as beer yeast, chocolate, cacao, cheese, butter, seafood powder, grain powder, malted rice, rice bran, soy lecithin, starch, fiber wastes, powder feed for laboratory animal breeding, pet food or the like can, for example, be used as the dietary attracting substance. Animal or vegetable fat and oil or fatty acid ester thereof, a food flavoring or the like can, for example, be used as the aromatic attracting substance. In addition, esters such as isovaleric acid, butyric acid, propionic acid, acetic acid, and formic acid, aldehydes, alcohols or the like can also be used as the aromatic attracting substance. As the mite attracting substance, one of the above-described substances can be used alone, or two or more of the above-described substances can be used in combination.

The mite attracting agent including the calcined shell and the mite attracting composition collects mites by the mite attracting substance and exterminates the mites. Therefore, the mite attracting agent can effectively reduce a mite allergen derived from dead bodies and droppings of the mites.

[Porous Substance]

The mite attracting composition may further include a porous substance, and at least a part of the mite attracting substance is preferably impregnated into the porous substance. At this time, the time of sustained release of the mite attracting substance can be lengthened, and thus, mites can be attracted for a long time. Silica gel, calcium chloride, activated carbon, diatomaceous earth powder agent, zeolite, ceramics or the like can be used as the porous substance. As a method for impregnating at least a part of the mite attracting substance into the porous substance, a mixed liquid of the above-described mite attracting substance can be mixed with the porous substance and the mite attracting substance can be impregnated into the pores of the porous substance, for example. The resultant impregnated substance can be further mixed with a powdery mite attracting substance and be subjected to drying and pulverization treatment, to thereby obtain a powdery mite attracting composition.

When the mite attracting composition is powdery, a number average particle size thereof is, for example, not less than 100 nm and not more than 5 mm, preferably not less than 1 μm and not more than 2 mm, and more preferably not less than 15 μm and not more than 150 μm.

A ratio of the mite attracting composition to the total amount of the mite attracting agent is, for example, not less than 10% by mass and not more than 90% by mass, preferably not less than 30% by mass and not more than 85% by mass, and more preferably not less than 50% by mass and not more than 80% by mass.

[C] Miticidal Substance

The mite attracting agent may further include a miticidal substance. The miticidal substance refers to a substance having the function of killing mites, and examples thereof include a porous substance such as silica gel, calcium chloride, activated carbon, diatomaceous earth powder agent, zeolite, or ceramics. As the miticidal substance, a fine powder of one of the above-described substances can be used alone, or fine powders of two or more of the above-described substances can be used in combination.

A ratio of the miticidal substance to the total amount of the mite attracting agent is, for example, not less than 5% by mass and not more than 50% by mass, preferably not less than 5% by mass and not more than 30% by mass, and more preferably not less than 10% by mass and not more than 25% by mass. When silica gel is, for example, used as the miticidal substance, the silica gel may function as a mite repellent if an amount of the silica gel included in the mite attracting agent is too large. Inclusion of the miticidal substance makes it possible to suppress the growth of attracted mites.

[Shape of Mite Attracting Agent]

Although not particularly limited, a shape of the mite attracting agent can be, for example, a film shape, a sheet shape, a rod shape, granular, or powdery. The mite attracting agent may be the one in which a mixture of the calcined shell and the mite attracting composition is contained in, impregnated into or covers a base material such as, for example, a fiber product including knit fabric, woven fabric, non-woven fabric, and paper, a resin molded body, activated carbon, or ceramics material. The mite attracting agent may also be subjected to treatment for preventing the mite attracting agent from being washed away.

[Allergen]

An allergen refers to a substance that causes an allergy, and is in many cases composed of protein or glycoprotein. When an allergen and an IgE antibody combine and a mast cell or the like is activated, an inflammation occurs. The reduced allergen is not particularly limited, and examples thereof include a mite allergen derived from mites, a pollen allergen, a caviar allergen, a dog and cat allergen, and the like. However, the reduced allergen is preferably a mite allergen. This is because about 70% of allergens in a room is a mite allergen. Particularly, the Epidermoptidae of the family Pyroglyphidae living in dust in a room make up a large proportion of a source of the allergen.

Among the Epidermoptidae, Dermatophagoides farinae and Dermatophagoides pteronyssinus are typical species, and Der f1/Der p1 derived from their droppings are particularly main allergens that cause the allergic diseases. In addition to these, Der f2/Der p2 derived from their dead bodies are also allergens.

Reduction in allergen means that an antibody no longer reacts with an allergen, and includes, for example, removal, capture, adsorption, decomposition, modification, or covering of a reaction site of an allergen.

<Mite Catcher>

A mite catcher includes a mite attracting agent. The above-described mite attracting agent can be used as the mite attracting agent. The mite catcher is not particularly limited, as long as it can be placed depending on the environment where mites live. However, a mat formed by sandwiching the mite attracting agent between non-woven fabrics, a sheet formed by spraying or applying the mite attracting agent onto a non-woven fabric, a porous material whose surface is covered with the mite attracting agent, or the like may be used as the mite catcher. These may be housed in a large-mesh fabric or non-woven fabric, a resin case having an entrance, or the like. The mite catcher including the mite attracting agent can attract and kill mites, and further, can reduce a mite allergen.

Examples

While the present invention will be described in more detail below with reference to Examples, the present invention is not limited thereto.

[Experiment 1: Verification of Mite Allergen Reducing Effect (Solution Method)]

A mite allergen and a mite attracting agent were brought into contact with each other to react for a certain time period, and then, a concentration of the mite allergen was measured with the ELISA, to thereby evaluate the mite allergen reducing effect. Specifically, the following procedure was used.

[1] Preparation of mite allergen Der f1

Mite-Df Feces AG (manufactured by LSL Co., Ltd.) was purchased as Der f1 (allergen derived from droppings of Dermatophagoides farinae) used to evaluate the allergen reducing effect, and a mite allergen solution (hereinafter, may be referred to as “Der f1 solution”) was prepared in accordance with the attached instructions. A Der f1 concentration of the prepared solution was determined using an ELISA kit for measuring a mite allergen (manufactured by Nichinichi pharmaceutical Co., Ltd.). In addition, a standard solution for a calibration curve was made based on the measured concentration.

[2] Method for reacting mite allergen solution and test powder

1) A test powder was added into a 20 mL beaker containing 19.5 mL of TBS-T (25 mM Tris, 150 mM NaCl, 0.02% Tween20, pH 7.5), and the mixture was stirred with a stirrer.

2) The Der f1 solution was added such that a final concentration became 100 ng/mL.

3) The mixture was reacted for 15 minutes, while stirring the mixture at room temperature.

4) The pH was adjusted to 7.5 with HCl.

5) The reaction solution was passed through a filter of 0.45 μm, to thereby remove a precipitate.

6) Using the collected solution as a test solution, a mite allergen concentration was measured in accordance with the following method.

[3] Measurement method with ELISA

1) As a capture antibody, anti-Der f1 mouse IgG (manufactured by INDOOR Biotechnologies, Inc., 1:2000) was diluted 2000 times with TBS-T, and 100 μL of the diluted solution was added to each well of a 96 well plate (manufactured by Nunc Co., Ltd.) and solid-phasing was performed at 4° C. overnight.

2) Each well was washed with TBS-T (25 mM Tris, 150 mM NaCl, 0.02% Tween20, pH 7.5), and then, blocking was performed at room temperature for 1 hour with TBS-T including 1% BSA.

3) After each well was washed with TBS-T, 100 μL of the test solution was added to each well and incubation was performed at 37° C. for 1 hour.

4) After each well was washed with TBS-T, a biotin label, anti-Der f1/p1 mouse IgG (manufactured by INDOOR Biotechnologies, Inc., 1:2000), serving as a detection antibody was diluted 2000 times with TBS-T, and 100 μL of the diluted solution was added to each well and incubation was performed at room temperature for 2 hours.

5) After each well was washed with TBS-T, 100 μL of an HRP label, streptavidin (manufactured by Abcam Plc) was added to each well and incubation was performed at room temperature for 30 minutes.

6) After each well was washed with TBS-T, color reaction was performed. The color reaction was performed using a SuperBlue TMB substrate (manufactured by KPL, Inc.) and the reaction was stopped by the TMB Stop Solution (manufactured by KPL, Inc.).

7) An absorbance at a wavelength of 450 nm was measured using a microplate reader (manufactured by Molecular Device Co.). Based on a calibration curve obtained from an absorbance of the standard solution for the calibration curve, a Der f1 concentration in each test solution was measured.

[4] An allergen reducing rate (%) was calculated based on the following equation:

allergen reducing rate (%)={(initial allergen concentration−allergen concentration after reaction)/initial allergen concentration}×100.

The test powders (50 mg) used in Experiment 1 are shown below:

Example 1: 15% by mass of scallop-derived high-temperature-calcined shell (calcination temperature: 1200° C.)
85% by mass of NK-001 base material

Comparative Example 1: NK-001 base material

Comparative Example 2: silica gel

Reference Example 1: scallop-derived high-temperature-calcined shell (calcination temperature: 1200° C.)

Reference Example 2: oyster-derived low-temperature-calcined shell (oyster shell nano-powder, calcination temperature: 300° C., Kure Brand Co., Ltd.).

The above-described NK-001 base material includes 85% by mass of a mite attracting composition and 15% by mass of a miticidal substance. A mixture including 1.5% by mass of a food flavoring (animal and vegetable fatty acid and esters thereof) as a mite attracting substance with respect to the mite attracting composition and 8.5% by mass of silica gel as a porous substance with respect to the mite attracting composition was used as the mite attracting composition. In addition, silica gel was used as the miticidal substance.

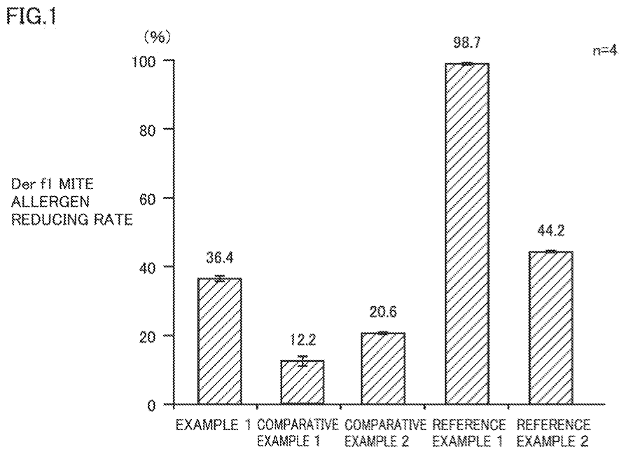

The mite allergen reducing rate of each test powder is shown in FIG. 1. The mite allergen reducing rate was low in the NK-001 base material in Comparative Example 1 and the silica gel in Comparative Example 2, whereas the mite allergen reducing rate was high in the high-temperature-calcined shell in Reference Example 1 and the low-temperature-calcined shell in Reference Example 2. It was found out that the calcined shell could reduce the mite allergen regardless of a shell type, and the high-temperature-calcined shell could reduce the mite allergen more significantly. In addition, the mite allergen reducing rate was higher in the test powder (mite attracting agent) in Example 1 obtained by mixing the calcined shell with the NK-001 base material than in Comparative Example 1. Therefore, it was found out that the mite attracting agent including the calcined shell and the mite attracting composition containing the mite attracting substance could reduce the mite allergen.

[Experiment 2: Verification of Mite Allergen Reducing Effect (Trace Liquid Method)]

The mite allergen reducing effect of each test powder was evaluated in accordance with the same method as that of Experiment 1, except for above-described [2] Method for reacting mite allergen solution and test powder. [2] was performed in accordance with the following procedure in order to conduct an experiment in the environment closer to reaction of the powders.

[2] Method for Reacting Mite Allergen Solution and Test Powder

1) A test powder was put into a beaker, and 25 μL of the mite allergen solution (including 2 μg of Der f1) was added and mixed with a dispensing spoon.

2) The mixture was allowed to stand still at room temperature for 15 minutes, and then, 19.5 mL of TBS-T (25 mM Tris, 150 mM NaCl, 0.02% Tween20, pH 7.5) was added.

3) The pH was adjusted to 7.5 with HCl.

4) The reaction solution was passed through a filter of 0.45 μm, to thereby remove a precipitate.

5) Using the collected solution as a test solution, a mite allergen concentration was measured with the ELISA.

The test powders (50 mg) used in Experiment 2 are shown below:

Example 1: 15% by mass of scallop-derived high-temperature-calcined shell (calcination temperature: 1200° C.)
85% by mass of NK-001 base material

Comparative Example 1: NK-001 base material

Comparative Example 2: silica gel

Reference Example 1: scallop-derived high-temperature-calcined shell (calcination temperature: 1200° C.)

Reference Example 3: scallop-derived high-temperature-calcined shell (scallop shell calcined product, calcination temperature: 1000° C., Furusato Bussan Ltd.)

Reference Example 4: surf clam-derived high-temperature-calcined shell (SURFCERA, calcination temperature: 900° C., Anshin Yasai Co., Ltd.).

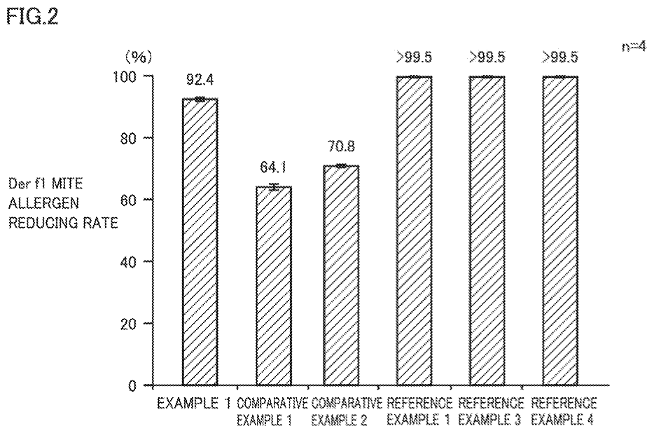

The mite allergen reducing rate of each test powder is shown in FIG. 2. According to this test method, the calcined shells in Reference Examples 1, 3 and 4 showed the higher mite allergen reducing effect, regardless of a shell type, than the NK-001 base material in Comparative Example 1 and the silica gel in Comparative Example 2. The mite allergen reducing rate was higher in the test powder (mite attracting agent) in Example 1 obtained by mixing the calcined shell with the NK-001 base material than in Comparative Example 1. Therefore, it was found out that the mite attracting agent including the calcined shell and the mite attracting composition containing the mite attracting substance could reduce the mite allergen.

[Experiment 3: Verification of Mite Allergen Reducing Effect in Accordance with Content of Calcined Shell (Trace Liquid Method)]

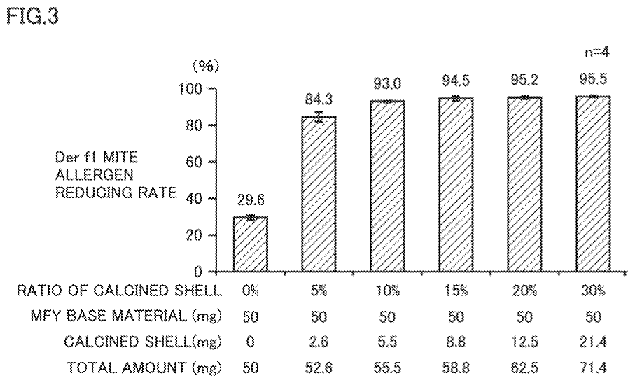

A content of the calcined shell in the mite attracting agent was changed from 0% by mass to 30% by mass as shown in FIG. 3 and the mite allergen reducing effect was verified in accordance with the same method as that of Experiment 2.

The test powders used in Experiment 3 are shown below:

MFY base material: mixed powder of 50% by mass of powder feed for animal breeding (MF) and 50% by mass of dried beer yeast (mite attracting substance)

calcined shell: scallop-derived high-temperature-calcined shell (calcination temperature: 1200° C.).

The mite allergen reducing rate of each test powder is shown in FIG. 3. The MFY base material that did not include the calcined shell showed the low mite allergen reducing rate, whereas the MFY base material (mite attracting agent) mixed with not less than 5% by mass of the calcined shell showed the high mite allergen reducing rate of not less than 80%. The MFY base material (mite attracting agent) mixed with not less than 10% by mass of the calcined shell showed the mite allergen reducing rate of not less than 90%, and the MFY base material (mite attracting agent) mixed with not less than 20% by mass of the calcined shell showed the mite allergen reducing rate of not less than 95%.

[Experiment 4: Verification of Mite Allergen Reducing Effect in Accordance with Content of Calcined Shell (Trace Liquid Method)]

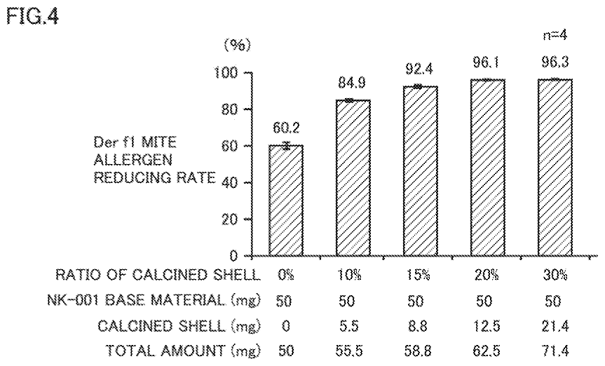

A content of the calcined shell in the mite attracting agent was changed from 0% by mass to 30% by mass as shown in FIG. 4 and the mite allergen reducing effect was verified in accordance with the same method as that of Experiment 2.

In Experiment 4, a scallop-derived high-temperature-calcined shell (calcination temperature: 1200° C.) was used as the calcined shell.

The mite allergen reducing rate of each test powder is shown in FIG. 4. The NK-001 base material that did not include the calcined shell showed the low mite allergen reducing rate, whereas the NK-001 base material (mite attracting agent) mixed with not less than 10% by mass of the calcined shell showed the high mite allergen reducing rate of not less than 80%. The NK-001 base material (mite attracting agent) mixed with not less than 15% by mass of the calcined shell showed the mite allergen reducing rate of not less than 90%, and the NK-001 base material (mite attracting agent) mixed with not less than 20% by mass of the calcined shell showed the mite allergen reducing rate of not less than 95%.

[Experiment 5: Verification of Mite Allergen Reducing Effect for Different Mite Allergen (Trace Liquid Method)]

The mite allergen reducing effect was verified in accordance with the same method as that of Experiment 2, except that a mite allergen different from that in each of Experiments 1 to 4 described above was used. Der p1 derived from droppings of Dermatophagoides pteronyssinus (Mite-Dp Feces Ag manufactured by LSL Co., Ltd.) was used as the mite allergen. In addition, anti-Der p1 mouse IgG (manufactured by INDOOR Biotechnologies, Inc., 1:1000) was used as a capture antibody of Der p1, and a biotin label, anti-Der f1/p1 mouse IgG (manufactured by INDOOR Biotechnologies, Inc., 1:1000) was used as a detection antibody.

In Experiment 5, the calcined shell, the MFY base material and the NK-001 base material used in each of Experiments 3 and 4 were used, and the base material (50 mg) and the calcined shell (0 mg or 8.8 mg) were mixed such that a ratio of the calcined shell in the mite attracting agent became 0% by mass or 15% by mass.

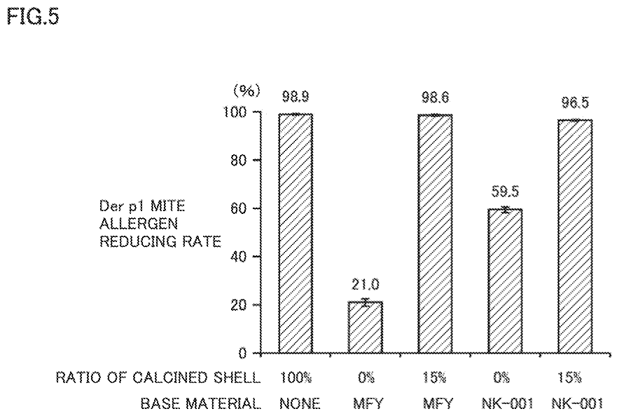

The mite allergen reducing rate of each test powder is shown in FIG. 5. The MFY base material and the NK-001 base material that did not include the calcined shell showed the low Der p1 mite allergen reducing rate, whereas the MFY base material and the NK-001 base material (mite attracting agent) including 15% by mass of the calcined shell showed the high Der p1 mite allergen reducing rate. It was found out that the mite attracting agent including the calcined shell and the mite attracting composition containing the mite attracting substance could reduce a plurality of mite allergens.

[Experiment 6: Verification of Mite Allergen Reducing Effect (Solution Method)]

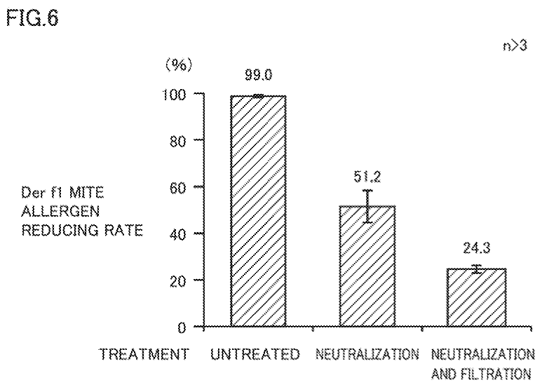

The calcined shell provides the mite allergen reducing effect, probably because the calcined shell is dissolved in water to become strongly alkaline. Therefore, verification was performed of how the allergen reducing effect changed at the time of neutralization of a solution in which the calcined shell was dissolved. The experiment was conducted in accordance with the same method as that of Experiment 1, except that the pH was neutralized to 7.5 before the mite allergen was added in above-described [2] Method for reacting mite allergen solution and test powder in Experiment 1, and TBS was used as a buffer (graph of neutralization treatment in FIG. 6).

In above-described [2] Method for reacting mite allergen solution and test powder in Experiment 1, the pH was neutralized to 7.5 before the mite allergen was added as described above, and further, it was verified whether or not a solution filtrated by a centrifugal filter of 0.45 μm had the mite allergen reducing capability (graph of neutralization and filtration treatment in FIG. 6). A high-temperature-calcined shell (calcination temperature: 1200° C.) was used as the test powder in Experiment 6.

The test solution that was not subjected to neutralization and filtration had the high mite allergen reducing effect, whereas the test solution subjected to neutralization treatment had the low mite allergen reducing rate, and thus, it is expected that the strong alkalinity contributed to a part of the mite allergen reducing effect. Furthermore, the test solution subjected to neutralization and filtration showed a certain level of mite allergen reducing effect, although the mite allergen reducing effect was lower. It is conceivable that the test solution subjected to neutralization and filtration includes a calcium ion generated by dissolution of the calcined shell and the calcium ion can contribute to reduction in mite allergen. However, when the neutralized test solution is filtrated, most of the powder calcined shell is removed. From the result of lowering of the mite allergen reducing effect by filtration, it was found out that the porous calcined shell also contributed to reduction in mite allergen. From the result of Experiment 6, it is conceivable that the calcined shell reduces the mite allergen based on a plurality of causes. The calcined shell is more excellent in safety than calcium oxide (quicklime) and other strongly alkaline aqueous solutions.

[Experiment 7: Verification of Mite Allergen Reducing Effect (Powder Method)]

In Experiment 7, 5 mg of a mite breeding culture medium (obtained by breeding Dermatophagoides farinae to a sufficient density in a MFY culture medium and then performing high-temperature and drying treatment to kill the mites, and an amount and a concentration of an allergen were determined in accordance with the ELISA method) including 8 μg of Der f1 was used instead of the Der f1 solution. A mixture of the calcined shell and the NK-001 base material in Experiment 4 mixed such that a ratio of the calcined shell in the mite attracting agent became 15% by mass was used as a test powder. The mite breeding culture medium and the test powder were mixed in a beaker and allowed to stand still at room temperature for 30 minutes. Then, 19.5 mL of TBS-T (pH 7.5) was added, and immediately after that, the pH was adjusted to 7.5 with HCl. A mite allergen concentration of the solution was measured in accordance with the same method as that of Experiment 1. According to the method in Experiment 7, the mite allergen reducing capability of the mite attracting agent can be verified in a state closer to the powder.

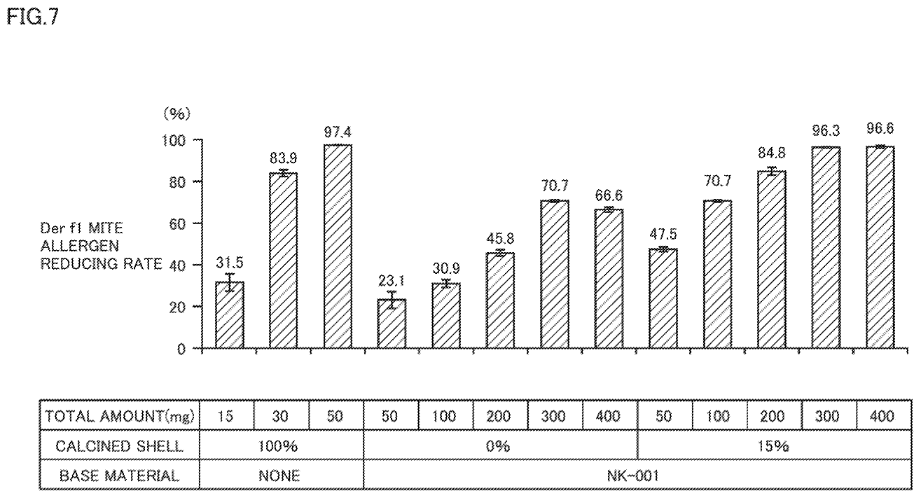

The result of Experiment 7 is shown in FIG. 7. In the method in Experiment 7 as well, the mite attracting agent in which the calcined shell was mixed with the NK-001 base material showed the higher mite allergen reducing effect than the NK-001 base material that did not include the calcined shell. Therefore, it was found out that the mite attracting agent including the calcined shell and the mite attracting composition containing the mite attracting substance could reduce the mite allergen.

[Experiment 8: Verification of Mite Allergen Reducing Effect of Mite Attracting Agent in Comparison with Calcium Hydroxide (Solution Method)]

The allergen reducing effect of calcium hydroxide and a mite attracting agent was verified in accordance with the same method as that of Experiment 1.

The test powders used in Experiment 8 are shown below:

Comparative Example 1: NK-001 base material (50 mg)

Comparative Example 3: calcium hydroxide (12.5 mg)

Comparative Example 4: calcium hydroxide (33.3 mg)

Example 2: mite attracting agent including 20% by mass of calcined shell
NK-001 base material (50 mg)+high-temperature-calcined shell (12.5 mg)

Example 3: mite attracting agent including 40% by mass of calcined shell
NK-001 base material (50 mg)+high-temperature-calcined shell (33.3 mg).

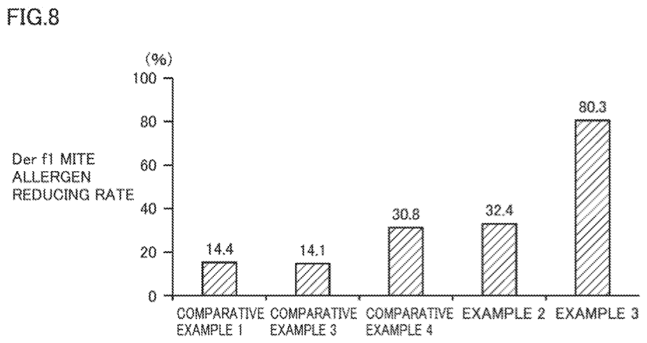

The mite allergen reducing rate of each test powder is shown in FIG. 8. The mite attracting agent in Example 2 included an amount of the NK-001 base material equal to that of the NK-001 base material in Comparative Example 1 and an amount of the high-temperature-calcined shell equal to that of calcium hydroxide in Comparative Example 3, and the allergen reducing rate of the mite attracting agent in Example 2 was higher than the additive effect predicted from the allergen reducing rate in each of Comparative Examples 1 and 3. Furthermore, the mite attracting agent in Example 3 included an amount of the NK-001 base material equal to that of the NK-001 base material in Comparative Example 1 and an amount of the high-temperature-calcined shell equal to that of calcium hydroxide in Comparative Example 4, and the allergen reducing rate of the mite attracting agent in Example 3 was significantly higher than the additive effect predicted from the allergen reducing rate in each of Comparative Examples 1 and 4. From this result, it was found out that the calcined shell was more excellent in allergen reducing effect than calcium hydroxide.

[Experiment 9: Verification of Mite Allergen Reducing Effect of Calcined Shell in Comparison with Calcium Oxide (Solution Method)]

The allergen reducing effect of calcium oxide and a mite attracting agent was verified in accordance with the same method as that of Experiment 1.

The test powders used in Experiment 9 are shown below:

Comparative Example 5: calcium oxide (12.5 mg)

Comparative Example 6: calcium oxide (21.4 mg)

Reference Example 5: high-temperature-calcined shell (12.5 mg)

Reference Example 6: high-temperature-calcined shell (21.4 mg).

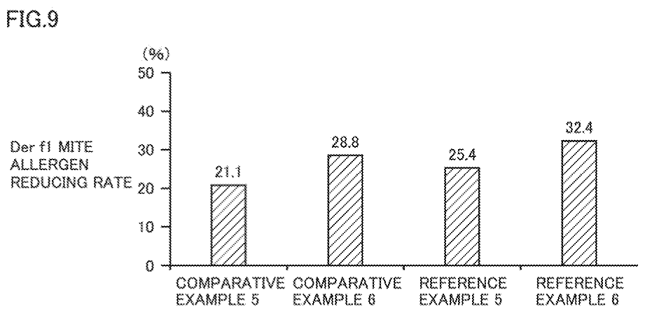

The mite allergen reducing rate of each test powder is shown in FIG. 9. Comparing Comparative Example 5 and Reference Example 5, the allergen reducing rate was higher by not less than 20% in Reference Example 5 including an amount of the high-temperature-calcined shell equal to that of calcium oxide in Comparative Example 5 than in Comparative Example 5 including calcium oxide. Similarly, comparing Comparative Example 6 and Reference Example 6, the allergen reducing rate was higher by not less than 10% in Reference Example 6 including an amount of the high-temperature-calcined shell equal to that of calcium oxide in Comparative Example 6 than in Comparative Example 6 including calcium oxide. From this result, it was found out that the calcined shell was more excellent in allergen reducing effect than calcium oxide.

Furthermore, a standard value of the amount of calcium oxide included in the high-temperature-calcined shell is set to be not less than 91% by mass, and the amount of calcium oxide included in the calcined shell in each of Reference Examples 5 and 6 was considered to be smaller than the amount of pure calcium oxide in each of Comparative Examples 5 and 6. However, the mite allergen reducing effect was more excellent in Reference Examples including the calcined shell. It was found out that calcium oxide derived from the calcined shell was more excellent in allergen reducing effect than pure calcium oxide due to hydration. In addition, it was suggested that the calcined shell also showed the allergen reducing effect based on a component other than calcium oxide.

[Experiment 10: Verification of Mite Allergen Reducing Effect of Calcined Shell in Comparison with Calcium Oxide (Solution Method)]

In Experiment 9, the strong alkalinity of the suspension of the test powder may have contributed to the mite allergen reducing effect. Therefore, an influence of the strong alkalinity was removed and the mite allergen reducing effect of calcium oxide and the calcined shell was verified. Experiment 10 was conducted in accordance with the same method as that of Experiment 1, except that the pH was neutralized to 7.5 before the mite allergen was added in above-described [2] Method for reacting mite allergen solution and test powder in Experiment 1.

The test powders used in Experiment 10 are shown below:

Comparative Example 7: calcium oxide (50 mg)

Comparative Example 8: calcium oxide (75 mg)

Reference Example 7: high-temperature-calcined shell (50 mg)

Reference Example 8: high-temperature-calcined shell (75 mg).

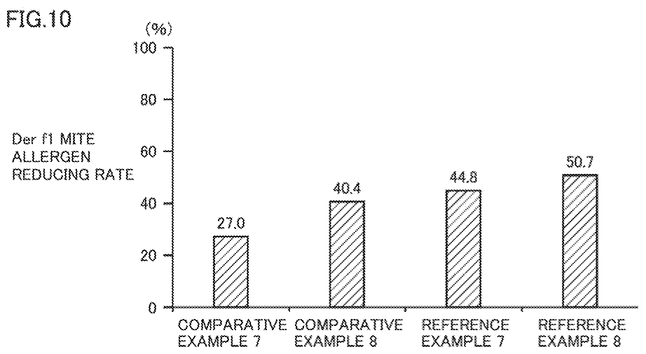

The mite allergen reducing rate of each test powder is shown in FIG. 10. The test powder in Reference Example 7 composed of an amount of the high-temperature-calcined shell equal to that of calcium oxide in Comparative Example 7 showed the significantly higher mite allergen reducing effect than that of Comparative Example 7. In addition, the test powder in Reference Example 8 composed of an amount of the high-temperature-calcined shell equal to that of calcium oxide in Comparative Example 8 showed the higher mite allergen reducing effect than that of Comparative Example 8. From these results, it was found out that the calcined shell was more excellent in allergen reducing effect than the calcium salt even when the influence of the strong alkalinity was removed.

[Experiment 11: Verification of Mite Allergen Reducing Effect of Shell Calcined at Various Temperatures]

The mite allergen reducing effect of a shell calcined at various temperatures was verified in accordance with the same method as that of Experiment 1.

The test powders used in Experiment 11 are shown below:

Reference Example 1: scallop-derived calcined shell (calcination temperature: 1200° C.)

Reference Example 2: oyster-derived calcined shell (calcination temperature: 300° C., Kure Brand Co., Ltd.)

Reference Example 9: oyster-derived calcined shell (calcination temperature: 850° C.)

Reference Example 10: scallop-derived calcined shell (calcination temperature: 850° C.)

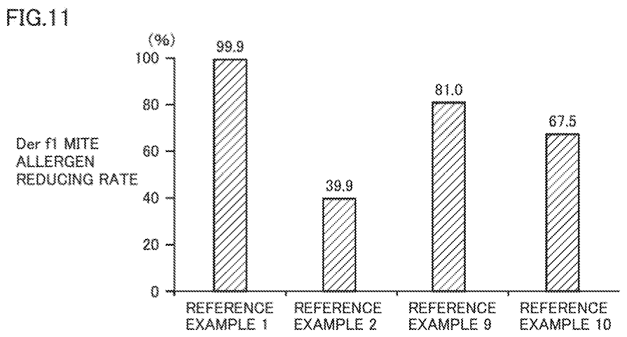

The mite allergen reducing rate of each test powder is shown in FIG. 11. The shells calcined at various temperatures had the mite allergen reducing effect. The shells calcined at the temperature of 1200° C. or 850° C. had the higher mite allergen reducing effect.

It should be understood that the embodiments and examples disclosed herein are illustrative and non-restrictive in every respect. The scope of the present invention is defined by the terms of the claims, rather than the description above, and is intended to include any modifications within the scope and meaning equivalent to the terms of the claims.

1. A mite attracting agent comprising: a calcined shell; and a mite attracting composition containing a mite attracting substance.

2. The mite attracting agent according to claim 1, wherein the calcined shell is a powder.

3. The mite attracting agent according to claim 1, wherein
the calcined shell includes a calcined shell derived from at least one selected from the group consisting of scallop, oyster and surf clam.

4. The mite attracting agent according to claim 1, wherein
a calcination temperature of the calcined shell is not less than 400° C. and not more than 1600° C.

5. The mite attracting agent according to claim 1, wherein
a ratio of the calcined shell to a total amount of the mite attracting agent is not less than 5% by mass.

6. The mite attracting agent according to claim 1, wherein
the mite attracting composition further includes a porous substance, and at least a part of the mite attracting substance is impregnated into the porous substance.

7. The mite attracting agent according to claim 1, further comprising silica gel.

8. The mite attracting agent according to claim 7, wherein
a ratio of the silica gel to a total amount of the mite attracting agent is not less than 5% by mass.

9. A mite catcher comprising the mite attracting agent as recited in claim 1.
